(19) United States
(12) Patent Application Publication
(10) Pub. No.: US 2025/0285251 A1
(43) Pub. Date: Sep. 11, 2025

(54) METHOD FOR THE FULL CORRECTION OF AN IMAGE, AND ASSOCIATED SYSTEM

(71) Applicant: FOGALE NANOTECH, Nîmes (FR)

(72) Inventors: Eric LEGROS, Nîmes (FR); Sylvain PETITGRAND, Caissargues (FR)

(21) Appl. No.: 18/862,094

(22) PCT Filed: May 12, 2023
(86) PCT No.: PCT/EP2023/062842

§ 371 Date: Oct. 31, 2024

(30) Foreign Application Priority Data
May 13, 2022 (FR) 2204555

(51) Int. Cl. G06T 7/00; G06T 3/4038; G06T 5/70; G06T 5/80; G06T 11/60

(52) U.S. Cl. CPC G06T 7/0002; G06T 3/4038; G06T 5/70; G06T 5/80; G06T 11/60

(57) ABSTRACT

A method for correcting at least one input image Ie into an image I_{Rk} and then into an image I_{R}, the input image originating from an optical sensor provided with photosites of different colors and being obtained through an optical imaging system, each sensor being associated with one system, the method involving
receiving the input image Ie,
iteratively modifying the image I_{Rk} being rendered at different iterations k, by iteratively processing a function E comprising two terms, i.e. a first term D, which depends on a comparison between the at least one input image Ie and a result I_{ck} of the image I_{Rk} being rendered at the iteration k reprocessed by information relating to the imaging system, and a second term P, which depends on one or more anomalies or penalties or defects within the image I_{Rk} being rendered at the iteration k, until the function E is minimized.

### TECHNICAL FIELD

The present invention relates to an image correction method. It likewise relates to a system for implementing such a method.

Such a device enables a user to perform full correction of several defects in an image. The field of the invention is more particularly, but non-limitingly, that of photographic cameras or digital cameras for mobile phones, tablets or laptops.

### PRIOR ART

For reasons of optical simplicity, in the camera modules of smartphones in particular, but not exclusively, color separation is achieved using so-called Bayer filter sensors, or Color Filter Arrays (CFAs). In fact, this technique has the enormous advantage of capturing several color bands through a single focusing optical system, illuminating the same image plane, so that the R, G, B (Red, Green, Blue) images are necessarily aligned with one another. (This may be true macroscopically, but at the level of the photosites (that is, photodiodes) used for detection, there is still a micro-shift due to the spacing of the photosites being different between the various color channels.) An elementary cell of such a sensor may contain, for example, 2×2 photosites, Red, Green1, Green2, Blue, or 4×4 photosites, including 1 group of 2×2 reds, 2 groups of 2×2 greens, one group of 2×2 blues.

The disadvantage of these CFA techniques is that the colors obtained are not detected at all points in space where a photosite on the sensor is located, since neither green nor blue are detected at the location of the red photosite, for example. The raw image thus obtained is said to be “mosaicked,” like a mosaic of different-colored tiles representing a more global image, which will appear all the more homogeneous the smaller the tiles or the further away they are seen. In order to obtain the final image, unless resolution is deliberately sacrificed by grouping all the color information of an elementary cell and creating a single pixel with 3 color intensities in the 3 R, G, B channels in the rendered image, the missing colors must be restored to hope for a resolution close to that of the elementary cell's photosites, that is, to disregard the mosaic of the raw image. In particular, it is common to see colored fringes on both sides of a photographed object, e.g. red on one side, blue on the other. These fringes are even more visible when the image is digitally zoomed. There are also effects for rendering false colors within the texture of an object, in this prior art. These effects appear in particular when the object features brightness jumps that can erroneously generate incorrect color interpolations by state-of-the-art demosaicing algorithms.

The prior art also includes Foveon technology sensors, where the various color channels are detected by specific absorption in several stacked photodiodes, with the photodiode encountered first absorbing and detecting blue, for example, then a subsequent one absorbing and detecting green, and finally the red that remains in the light stream is detected in the deeper layers. In this way, the sensor renders 3 color pixels at identical positions, avoiding the need to demosaic the image, since the pixels render color information at identical locations.

What is more, despite the stacking of several lenses of different materials in light-focusing lens assemblies in camera modules, for example in even high-end smartphones, it is not always completely possible to suppress color-focusing effects at different distances between them, and in particular over the entire field of view of the lens assembly. These defects are called chromaticity aberrations. And even if it were theoretically possible to design such a “perfect” lens assembly, the practical realization of these lens assemblies involves a number of deviations from the ideal design values, which ultimately result in focusing defects that vary throughout the image, inducing a spreading out of the light spot instead of obtaining a single point, and moreover that differ according to the position on the sensor field, also depending on the wavelength. This also results in geometric deformations, making the resulting image different from a perfect homothety with respect to the observed scene; these are known as optical distortions, and can be grouped together with the effects of blurring caused by the spreading of light under the term optical aberration. Mathematically, this leads to changes in the angles between the lines of an object and reality, and to twists in these lines, known, for example, as “barrel” distortion, or “cushion” distortion for the main mode of these distortions, depending on whether they compress the corners toward the center of the image, or on the contrary, spread them outwards.

Again, when brightness is below a certain threshold, the signal-to-noise ratio of the pixels can deteriorate significantly, leading either to a desire to expose pixels for longer, but to the detriment of brighter areas of the image, or to the risk of obtaining motion blur when shooting. Image processing must, depending on the conditions, reduce this noise, which can manifest itself in particular through the appearance of parasitic dots of the 3 colors R, G, B, randomly in the texture of objects, without any special processing, in addition to spatial luminance noise.

There are known ways of reducing image noise based on an assumption of spatial homogeneity: the intensity of a point can be replaced by that of its neighbors, in an averaging operation. This operation can be described as spatial smoothing. However, the higher the noise level, the more this technique reduces the spatial resolution of the image, making it blurred.

In the end, all these defects result in image rendering errors that are perceptible to users of smartphone camera modules, for example. Similarly, for a camera module used, for example, in automatic car driving, these defects can hamper the recognition of objects in the observed scene.

The prior art of image rendering also generally consists in guessing the photosites that are spatially missing in the CFA color matrix, by laws that take into account adjacent photosites, either of the same color, or of another color by an underlying assumption that the brightness obtained from local R, G, B photosites would be representative of the locally undetected color, or still other methods tending to minimize the most well-known artifacts, such as the appearance of false colors around objects, or in areas of strong variation, and so-called “zipper” effects due to the erroneous rendering of false periodic alternations of color or brightness, generally on contours, recalling the image of such an object, hence the name artifact.

Aliasing effects may appear on the edges of objects, due to the pixelization (or discretization) limit of the image, generally on contours that are not parallel to the sensor's periodicity axes, that is, anything that is not at multiple angles of 45° or 90° for standard CFA sensor geometries, for example.

Together, these two methods of noise reduction and demosaicing result in images below the resolution limit of the photosites, degrading the possible detection sharpness, in addition to the artifacts mentioned above. Typically, an image pre-processed in this way then undergoes distortion corrections (or geometric aberration corrections) to restore a homothetic relationship between a particular plane of the scene and the image it produces. It can also be corrected for chromatic aberrations.

In addition, at the end of these prior art image correction methods, since the noise reduction processing has produced additional blurring in the image, in addition to the blurring defects due to not necessarily perfect focusing at all points of the field of view as already mentioned, an enhancement step is carried out, which involves replacing the intensity of a point in the image by a convolution with a coefficient matrix to produce an enhancement of the high spatial frequency components, in order to restore a certain sharpness lost by the processing method as a whole, as well as by the imperfect optical focusing itself.

Blurring defects are also known which are induced by relative movement of the camera module with respect to the observed scene. Generally, compensation systems for movements opposite those of the device containing the camera module are deliberately produced to stabilize the image. However, if only for reasons of mechanical inertia, there may still be a gap between the ideal position that should have been generated and the one actually obtained. This deviation from the ideal trajectory will cause the points to spread out, in a particular direction for example, or in a more diffuse pattern depending on the shooting time. There are methods of compensating for these micro-defects in post-correction software, by finding out what they cause, and compensating at the image level.

The purpose of the present invention is to provide a method for correcting an image:
enabling two different types of defect to be corrected simultaneously (that is, not one after the other), and/or
faster than the state of the art, and/or
enabling a corrected image resolution to be obtained which is preferably equal to or even lower than the photosite resolution limit.

### DISCLOSURE OF THE INVENTION

This objective is achieved with a method for correcting at least one input image Iₑ into an image I_{Rk} being rendered and then a rendered image I_{R}, the at least one input image originating from at least one optical sensor provided with photosites of different colors and being obtained through at least one optical imaging system (also referred to hereinafter as at least one imaging system or at least one optical system), each sensor being associated with an optical imaging system, said method comprising:
receiving the at least one input image Iₑ,
iteratively modifying the image I_{Rk} being rendered at different iterations k by iteratively processing a function E comprising two terms, that is:
   a first term D, which depends on a comparison between, on the one hand, the at least one input image Iₑ and, on the other hand, a result I_{ck} of the image I_{Rk} being rendered at the iteration k reprocessed by information relating to the at least one imaging system (preferably, the first term D depending on difference(s) between, on the one hand, the at least one input image Iₑ and, on the other hand, the result I_{ck} of a modification of the image I_{Rk} being restored at the iteration k at least by a function describing the response of the at least one imaging system, the function describing the response of the at least one imaging system depending on a distance (Z) between the at least one sensor and an object imaged by the at least one sensor, and/or a distance (zₒₛ) between a part of the at least one imaging system and an object imaged by the at least one sensor), and
   a second term P, which depends on one or more anomalies or penalties or defects within the image I_{Rk} being rendered at the iteration k, until minimizing, at least below a certain minimization threshold or after a certain number of iterations, a cumulative effect:
   of one or more differences of the first term D between the at least one input image Iₑ and the result I_{ck}, and
   of one or more anomalies or penalties or defects on which the second term P depends within the image I_{Rk} being rendered at the iteration k so that the rendered image I_{R} corresponds to the image being rendered at the iteration for which this minimization is obtained.

Thus, by such iteration and minimization, the method according to the invention can simultaneously correct at least two of the following types of defects of the at least one input image among:
Optical, geometric and/or chromatic aberration, and/or
Distortion, and/or
Mosaicing, and/or
Detection noise, and/or
Blurring, and/or
Residual non-compensation of a movement, and/or
Artifacts induced by spatial discretization.

This avoids the disadvantages of successive defect corrections:
Very time-consuming, and/or
Can accentuate or generate a defect (for example, after blur processing, noise reduction processing can reintroduce blur into the image).

Minimizing the cumulative effect may correspond to minimizing the function E.

The E function may comprise (or even consist of) the sum of the first term D and the second term P.

The first term D may depend on the difference(s) between, on the one hand, the at least one input image Iₑ and, on the other hand, the result I_{ck} of a modification of the image I_{Rk} being rendered at the iteration k at least by a function describing the response of the at least one imaging system.

The result I_{ck} may comprise and/or consist of a convolution product of the image I_{Rk} being rendered at the iteration k by the function describing the response of the at least one imaging system, and possibly processed by a geometric transformation GT.

The function describing the response of the at least one imaging system can be an optical transfer function (OTF) of the at least one imaging system or a point spread function (PSF) of the at least one imaging system.

The function describing the response of the at least one imaging system may depend on:
a distance (Z) between the at least one sensor and an object imaged by the at least one sensor, and/or
a distance (z_{co}) between a part of the at least one imaging system and the at least one sensor, and/or
a distance (zₒₛ) between a part of the at least one imaging system and an object imaged by the at least one sensor, and/or
a state of the at least one imaging system, such as a zoom or focus or digital aperture setting of the at least one imaging system, and/or
the pixel of the image being rendered and/or the photosite of the at least one sensor, and/or
one or more angles between the at least one sensor and the at least one imaging system.

The method according to the invention may comprise passing light through the at least one optical system to the at least one sensor so as to generate the at least one input image.

The method according to the invention may comprise displaying the rendered image on a screen.

Additionally, such a global iterative method leaves open the possibility of obtaining a corrected image resolution equal to or even lower than the photosite resolution limit (although in some embodiments the corrected image resolution may be higher than the photosite resolution limit).

The rendered image may have a resolution greater than or equal to that of the combination of all the photosites of all the colors of the at least one sensor.

The method according to the invention may comprise generating, from several input images, an initial version of the image I_{Rk} being rendered for the first iteration k=1 by a combination between these several input images Iₑ.

The second term P may comprise at least one component P₁ whose effect is minimized for small intensity differences between neighboring pixels of the image I_{Rk} being rendered at the iteration k.

The second term P may comprise at least one component P₃ whose effect is minimized for small differences in hue between neighboring pixels of the image I_{Rk} being rendered at the iteration k.

The second term P may comprise at least one component P₂ whose effect is minimized for low frequencies of direction changes between neighboring pixels of the image I_{Rk} drawing a contour.

Another aspect of the present invention relates to a computer program comprising instructions which, when executed by a computer, implement the steps of the method according to the invention.

Another aspect of the invention relates to a computer program product comprising instructions which, when the program is executed by a computer, cause the computer to perform the steps of the method according to the invention.

Another aspect of the invention relates to a computer-readable storage medium comprising instructions which, when executed by a computer, cause the computer to perform the steps of the method according to the invention.

According to another aspect of the invention, a device is proposed for correcting at least one input image Iₑ into an image I_{Rk} being rendered and then a rendered image I_{R}, the at least one input image originating from at least one optical sensor provided with photosites of different colors and being obtained through at least one optical imaging system, each sensor being associated with an optical imaging system, said device comprising:
means for receiving the at least one input image Iₑ,
processing means arranged and/or programmed for iteratively modifying the image I_{Rk} being rendered at different iterations k by iteratively processing a function E comprising two terms, that is:
   a first term D, which depends on a comparison between, on the one hand, the at least one input image Iₑ and, on the other hand, a result I_{ck} of the image I_{Rk} being rendered at the iteration k reprocessed by information relating to the at least one imaging system (preferably, the first term D depending on difference(s) between, on the one hand, the at least one input image Iₑ and, on the other hand, the result I_{ck} of a modification of the image I_{Rk} being restored at the iteration k at least by a function describing the response of the at least one imaging system, the function describing the response of the at least one imaging system depending on a distance (Z) between the at least one sensor and an object imaged by the at least one sensor, and/or a distance (zₒₛ) between a part of the at least one imaging system and an object imaged by the at least one sensor), and
   a second term P, which depends on one or more anomalies or penalties or defects within the image I_{Rk} being rendered at the iteration k, until minimizing, at least below a certain minimization threshold or after a certain number of iterations, a cumulative effect:
   of one or more differences of the first term D between the at least one input image Iₑ and the result I_{ck}, and
   of one or more anomalies or penalties or defects on which the second term P depends within the image I_{Rk} being rendered at the iteration k so that the rendered image I_{R} corresponds to the image being rendered at the iteration for which this minimization is obtained.

The processing means may be arranged and/or programmed to simultaneously correct at least two of the following types of defects of the at least one input image among:
Optical, geometric and/or chromatic aberration, and/or
Distortion, and/or
Mosaicing, and/or
Detection noise, and/or
Blurring, and/or
Residual non-compensation of a movement, and/or
Artifacts induced by spatial discretization.

Minimizing the cumulative effect may correspond to minimizing the function E.

The E function may comprise (or even consist of) the sum of the first term D and the second term P.

The first term D may depend on the difference(s) between, on the one hand, the at least one input image Iₑ and, on the other hand, the result I_{ck} of a modification of the image I_{Rk} being rendered at the iteration k at least by a function describing the response of the at least one imaging system.

The result I_{ck} may comprise and/or consist of a convolution product of the image I_{Rk} being rendered at the iteration k by the function describing the response of the at least one imaging system, and possibly processed by a geometric transformation GT.

The function describing the response of the at least one imaging system can be an optical transfer function (OTF) of the at least one imaging system or a point spread function (PSF) of the at least one imaging system.

The function describing the response of the at least one imaging system may depend on:
a distance (Z) between the at least one sensor and an object imaged by the at least one sensor, and/or
a distance (z_{co}) between a part of the at least one imaging system and the at least one sensor, and/or
a distance (zₒₛ) between a part of the at least one imaging system and an object imaged by the at least one sensor, and/or
a state of the at least one imaging system, such as a zoom or focus or digital aperture setting of the at least one imaging system, and/or
the pixel of the image being rendered and/or the photosite of the at least one sensor, and/or
one or more angles between the at least one sensor and the at least one imaging system.

The device according to the invention may comprise the at least one sensor and the at least one optical system which is arranged for passing light through the at least one optical system to the at least one sensor so as to generate the at least one input image.

The device according to the invention may comprise means arranged and/or programmed to display the rendered image on a screen.

The rendered image may have a resolution greater than or equal to that of the combination of all the photosites of all the colors of the at least one sensor.

The processing means may be arranged and/or programmed to generate, from several input images, an initial version of the image being rendered I_{Rk} for the first iteration k=1 by a combination between these several input images Iₑ.

The second term P may comprise at least one component P₁ whose effect is minimized for small intensity differences between neighboring pixels of the image I_{Rk} being rendered at the iteration k.

The second term P may comprise at least one component P₃ whose effect is minimized for small differences in hue between neighboring pixels of the image I_{Rk} being rendered at the iteration k.

The second term P may comprise at least one component P₂ whose effect is minimized for low frequencies of direction changes between neighboring pixels of the image I_{Rk} drawing a contour.

According to still another aspect of the present invention, proposed is:
a smartphone (smart cell phone or multifunction cell phone), implementing a correction method according to the invention to correct an image acquired by the smartphone (more specifically by the camera module(s), comprising a lens assembly and a sensor, of the smartphone) and/or comprising a correction device according to the invention arranged and/or programmed to correct an image acquired by the smartphone (more specifically by the camera module(s), comprising a lens assembly and a sensor, of the smartphone), and/or
a use of a correction device according to the invention and/or a correction method according to the invention within a smartphone (also called smart cell phone or multifunction cell phone), to correct an image acquired by the smartphone (more specifically by the camera module(s), comprising a lens assembly and a sensor, of the smartphone), and/or
a tablet computer, implementing a correction method according to the invention to correct an image acquired by the tablet computer (more specifically by the camera module(s), comprising a lens assembly and a sensor, of the tablet computer) and/or comprising a correction device according to the invention arranged and/or programmed to correct an image acquired by the tablet computer (more specifically by the camera module(s), comprising a lens assembly and a sensor, of the tablet computer), and/or
a use of a correction device according to the invention and/or a correction method according to the invention within a tablet computer, to correct an image acquired by the tablet computer (more specifically by the camera module(s), comprising a lens assembly and a sensor, of the tablet computer), and/or
a photographic camera (preferably of the reflex or bridge or compact type), implementing a correction method according to the invention to correct an image acquired by the photographic camera (more specifically by the camera module(s), comprising a lens assembly and a sensor, of the photographic camera) and/or comprising a correction device according to the invention arranged and/or programmed to correct an image acquired by the photographic camera (more specifically by the camera module(s), comprising a lens assembly and a sensor, of the photographic camera),
a use of a correction device according to the invention and/or a correction method according to the invention within a photographic camera (preferably of the reflex or bridge or compact type), to correct an image acquired by the photographic camera (more specifically by the camera module(s), comprising a lens assembly and a sensor, of the photographic camera), and/or
a vehicle (preferably automotive, but may be of any type), implementing a correction method according to the invention to correct an image acquired by the vehicle (more specifically by the camera module(s), comprising a lens assembly and a sensor, of the vehicle) and/or comprising a correction device according to the invention arranged and/or programmed to correct an image acquired by the vehicle (more specifically by the camera module(s), comprising a lens assembly and a sensor, of the vehicle); the corrected image preferably being used or intended to be used by the vehicle for autonomous driving of the vehicle, and/or
a use of a correction device according to the invention and/or a correction method according to the invention within a vehicle (preferably automotive, but which may be of any type), to correct an image acquired by the vehicle (more specifically by the camera module(s), comprising a lens assembly and a sensor, of the vehicle); the corrected image preferably being used or intended to be used by the vehicle for autonomous driving of the vehicle, and/or
a video surveillance system (preferably of a building and/or a geographical area), implementing a correction method according to the invention to correct an image acquired by the video surveillance system (more precisely by the camera module(s), comprising a lens assembly and a sensor, of the video surveillance system) and/or comprising a correction device according to the invention arranged and/or programmed to correct an image acquired by the video surveillance system (more specifically by the camera module(s), comprising a lens assembly and a sensor, of the video surveillance system), and/or
a use of a correction device according to the invention and/or a correction method according to the invention within a video surveillance system (preferably of a building and/or a geographical area), to correct an image acquired by the video surveillance system (more precisely by the camera module(s), comprising a lens assembly and a sensor, of the video surveillance system), and/or
a drone, implementing a correction method according to the invention to correct an image acquired by the drone (more specifically by the camera module(s), comprising a lens assembly and a sensor, of the drone) and/or comprising a correction device according to the invention arranged and/or programmed to correct an image acquired by the drone (more specifically by the camera module(s), comprising a lens assembly and a sensor, of the drone); the corrected image preferably being used or intended to be used by the drone:
   in the field of agriculture, the image acquired by the drone preferably being an image of plant crops, and/or
   in the field of pollution and/or land use analysis, the image acquired by the drone preferably being a multi-wavelength band image, and/or
a use of a correction device according to the invention and/or a correction method according to the invention within a drone, to correct an image acquired by the drone (more specifically by the camera module(s), comprising a lens assembly and a sensor, of the drone); the corrected image preferably being used or intended to be used by the drone:
   in the field of agriculture, the image acquired by the drone preferably being an image of plant crops, and/or
   in the field of pollution and/or land use analysis, the image acquired by the drone preferably being a multi-wavelength band image, and/or
a satellite, implementing a correction method according to the invention to correct an image acquired by the satellite (more specifically by the camera module(s), comprising a lens assembly and a sensor, of the satellite) and/or comprising a correction device according to the invention arranged and/or programmed to correct an image acquired by the satellite (more specifically by the camera module(s), comprising a lens assembly and a sensor, of the satellite); the corrected image preferably being used or intended to be used by the satellite:
   in the field of agriculture, the image acquired by the satellite preferably being an image of plant crops, and/or
   in the field of pollution and/or land use analysis, the image acquired by the satellite preferably being a multi-wavelength band image, and/or
a use of a correction device according to the invention and/or a correction method according to the invention within a satellite, to correct an image acquired by the satellite (more specifically by the camera module(s), comprising a lens assembly and a sensor, of the satellite); the corrected image preferably being used or intended to be used by the satellite:
   in the field of agriculture, the image acquired by the satellite preferably being an image of plant crops, and/or
   in the field of pollution and/or land use analysis, the image acquired by the satellite preferably being a multi-wavelength band image, and/or
an apparatus for medical imaging of the human and/or animal body (preferably by MRI and/or X-ray and/or Gamma-ray and/or ultrasound), implementing a correction method according to the invention to correct an image acquired by the medical imaging apparatus and/or comprising a correction device according to the invention arranged and/or programmed to correct an image acquired by the medical imaging apparatus, and/or
a use of a correction device according to the invention and/or a correction method according to the invention within a medical imaging device for imaging the human and/or animal body (preferably by MRI and/or X-ray and/or Gamma-ray and/or ultrasound), to correct an image acquired by the medical imaging device, and/or
a microscopy apparatus, implementing a correction method according to the invention to correct an image acquired by the microscopy apparatus and/or comprising a correction device according to the invention arranged and/or programmed to correct an image acquired by the microscopy apparatus, and/or
a use of a correction device according to the invention and/or a correction method according to the invention within a microscopy apparatus, to correct an image acquired by the microscopy apparatus, and/or
an apparatus for tomographic imaging of an image acquired in several wavelength bands (preferably in the field of health and/or in the field of industry and/or in the field of agriculture), implementing a correction method according to the invention to correct an image acquired by the tomographic imaging apparatus and/or comprising a correction device according to the invention arranged and/or programmed to correct an image acquired by the tomographic imaging apparatus, and/or
a use of a correction device according to the invention and/or a correction method according to the invention within a tomographic imaging apparatus of an image acquired in several wavelength bands (preferably in the field of health and/or in the field of industry and/or in the field of agriculture), to correct an image acquired by the tomographic imaging apparatus.

### DESCRIPTION OF THE FIGURES AND EMBODIMENTS

Other benefits and features shall become evident upon examining the detailed description of entirely non-limiting embodiments and implementations, and from the following enclosed drawings:

FIG. 1 shows various steps 2, 5, 7, 8 of a preferential embodiment of the method 1 according to the invention,

FIG. 2 shows various steps 2, 5, 7, 8, 11, 12, 13 of the preferential embodiment of the method 1 according to the invention, and

FIG. 3 shows a possible depiction of pixel objects in the method 1: a pixel with three color properties R, G, B. Its position is that of its X, Y position, represented by the indexing to access it, which translates its position in the image I_{Rk} or I_{R}.

These embodiments are in no way limiting, and in particular, it is possible to consider variants of the invention that comprise only a selection of the features disclosed hereinafter in isolation from the other features disclosed (even if that selection is isolated within a phrase comprising other features), if this selection of features is sufficient to confer a technical benefit or to differentiate the invention with respect to the prior state of the art. This selection comprises at least one preferably functional feature which lacks structural details, and/or only has a portion of the structural details if that portion is only sufficient to confer a technical benefit or to differentiate the invention with respect to the prior state of the art.

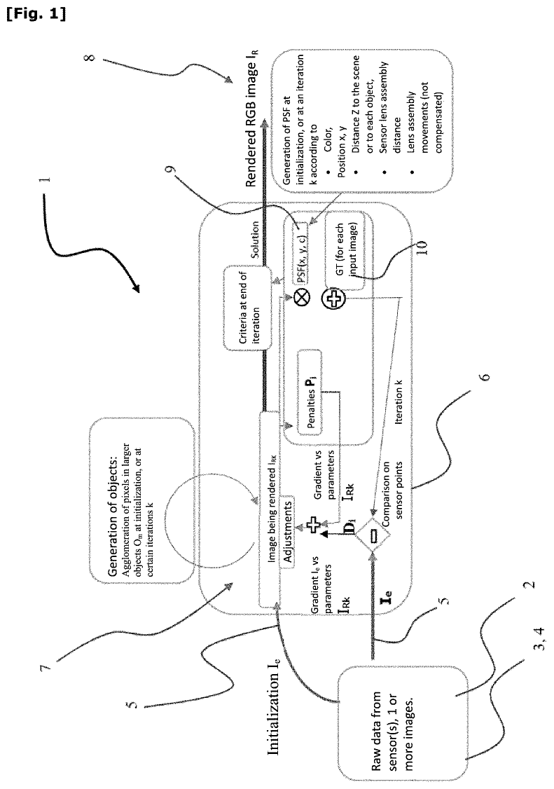

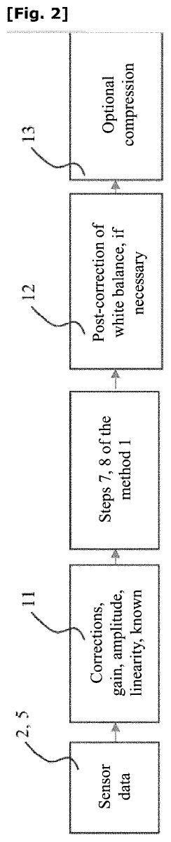

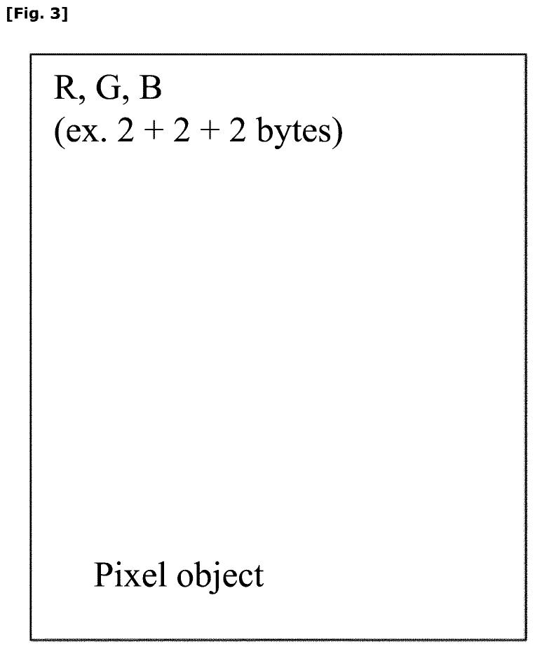

With reference to FIGS. 1 to 3, the main steps of an embodiment of a correction method 1 according to the invention will first be disclosed by way of an embodiment of a device according to the invention comprising the means 6 (and preferably also 3 and 4) disclosed below.

The method 1 is a method for correcting at least one input image Iₑ into an image being rendered I_{Rk} and then a rendered image I_{R}.

The at least one input image Iₑ is acquired 2 by at least one optical sensor 3 equipped with photosites of different colors. Each sensor 3, more specifically each photosite of each sensor, is arranged to convert received photons into an electrical signal. Different photosites are said to have different colors if they have different properties for transforming photons into an electrical signal, depending on the wavelength of the photons. The “color” of a photosite corresponds to the wavelength of the photons for which the photosite will have the best or substantially the best rate of transformation of these photons into electrical energy. A digital camera sensor may be considered by way of example sensor 3.

The at least one input image Iₑ is obtained through at least one optical imaging system 4. Each optical system 4 may typically be a system comprising several lenses, potentially movable relative to one another for focus and/or zoom adjustment, and making up the optical system of a camera, a webcam, or a reflex, bridge or compact digital camera, a smartphone, a tablet, a laptop computer, etc. This optical system may therefore be more or less compact, comprise more or fewer lenses of various possible materials (glass, plastic, etc.) with different optical indices, etc.

Hereinafter, the term “camera module” will refer to an assembly comprising a sensor 3 and an imaging system 4.

The sensor 3 or each of the sensors 3 is associated with the optical imaging system 4 or with one of the optical imaging systems 4. In other words, there is typically a set or system of lenses 4 in front of each sensor 3.

Thus, the method 1 comprises a passage of light through the at least one optical system 4 to the at least one sensor 3 so as to generate the at least one input image Iₑ, typically one image Iₑ per sensor 3 provided with a system 4.

The method 1 comprises receiving 5 the at least one input image Iₑ, by technical means 6 such as computing and/or analysis and/or processing technical means 6.

The means 6 comprise at least one of a computer, a central processing or computing unit, an analog electronic circuit (preferably dedicated), a digital electronic circuit (preferably dedicated), and/or a microprocessor (preferably dedicated), and/or software means.

The method 1 further comprises an iterative modification 7 (by technical means 6 which are arranged and/or programmed to this end) of the image I_{Rk} being rendered at different iterations numbered k (k being a positive natural number from 1 to N with N the total number of iterations), by iterative processing of a function E comprising two terms (more exactly comprising or even consisting of the sum of the first term D and the second term P), including:
a first term D, which depends on a comparison between, on the one hand, the at least one input image Iₑ and, on the other hand, a result I_{ck} of the image I_{Rk} being rendered at the iteration k reprocessed by information 9 relating to the at least one imaging system 4, and
a second term P, which depends on one or more anomalies or penalties or defects within the image I_{Rk} being rendered at the iteration k, until minimizing, at least below a certain minimization threshold or after a certain number of iterations, a cumulative effect (minimization of the cumulative effect corresponding to minimization of the function E):
of one or more differences of the first term D between the at least one input image Iₑ and the result I_{ck}, and
of one or more anomalies or penalties or defects on which the second term P depends within the image I_{Rk} being rendered at the iteration k so that the rendered image I_{R} (by the means 6 in a rendering step 8 of the rendered image) corresponds to the image being rendered Irk_{Rk} at the iteration for which this minimization is obtained.

This rendering step 8 may optionally be followed by:
a step 12 for post-correction of the image I_{R} (white balance, etc.), and/or
a compression step 13 of I_{R}

In the case of several sensors 3 or of a sensor generating several images Iₑ, the means 6 (which are arranged and/or programmed to this end) generate, from these several input images Iₑ, the initial version of I_{Rk} for the first iteration k=1 by a combination between these several input images Iₑ, which makes it possible, for example, to produce a “panoramic” image I_{Rk} for k=1 by combining several smaller images Iₑ from the different sensors 3.

This method 1 is therefore implemented by a processing loop 7 acting directly between the input image Iₑ (optionally corrected (step 11) by directly available offsets and gain, or even non-linearities), and the image being rendered I_{Rk}, which is generated by directly taking into account a maximum number of elements that accurately model the geometry of all the parts of the at least one sensor 3, the optical focusing effects throughout the at least one sensor 3, any movements, and the effects of distances modifying the focusing effects.

The at least one image Iₑ comprises one or more input images, taken:
by the same system of camera(s) 3 & lens assembly(ies) 4, with a single input image, or several images, or
by several lens assemblies 4, such as those, for example, of a smartphone equipped with several cameras 4, taken at similar, or close, instants.

In more detail, the image Iₑ processing method 1 is therefore based on the following inputs:

1) the at least one input image Iₑ. Each input image Iₑ uses or directly comprises the intensities of the photosites R (Red), G (Green), B (Blue) (or according to another possible choice of color matrix such as R (Red), Y (Yellow), W (White), B (Blue)) of the sensor 3 associated with this image Iₑ, preferably before any noise reduction operation by spatial smoothing, which is no longer required, or any attempt to restore missing color, which is also no longer required (except in special cases). This image is called input Iₑ. However, it can also preferably comprise taking into account (step 11) photosite gain and black level information, for example according to a table of values specific to the detection sensor, photosite by photosite (or region by region, as the case may be), that is, the intensities detected by the photosites will preferably have been corrected to have the same digital restoration of the black level, and a rendering of a homogenized reference white level, e.g. uniform, or according to a reference in line with the subsequent point spread correction processing. Should the detection prove to be non-linear, compressing high intensities for example, the method 1 can also make these corrections in this so-called input image Iₑ, although these calculations can also be performed in the iteration loop 7 if this is of interest, which may be the case if non-linearity or saturation relationships are complex. Doing them in this step means they only need to be done once per image, and is therefore potentially advantageous in terms of computational volume. Finally, if any photosites are deemed non-functional, they should be excluded from the comparison steps in the calculations of gradients with respect to the distance D or distances Di disclosed later.

2) information 9 generated from a relatively precise knowledge of the optical focusing faults of the lens assembly 4 or the at least one imaging system 4, and preferably also differentially for each color channel detected. This information may comprise reading a table giving access to particular information linked to the defects in the design of the lens assembly 4 or the at least one imaging system 4, as well as the usage conditions of the lens assembly 4 or the at least one imaging system 4, such as the distance between each lens assembly or system 4 and the scene observed through this lens assembly or system 4, either considered according to a single distance, or differentiated into distance object by object of the scene, and the distance between the lens assembly or system 4 and the imaging sensor 3 associated with this lens assembly or system 4, and optionally variations in angle between these elements. This information is used to synthesize a rendering of point spread functions (PSF) 9, which can be represented by matrices of coefficients capable of producing, by convolution with the intensities ideally emitted by each point of the scene, the intensities obtained at the image sensor 3 or at least one sensor 3, for each color channel. In the event that uncompensated or only partially compensated displacement defects are known, for example through a depiction of the residual non-compensated movement of the camera module relative to the scene, the PSF 9 matrices at different positions are summed, weighted by the time that has elapsed there, to calculate a composite PSF 9 including these residual non-compensated movements, and to use this form of PSF 9 as an input element for image rendering iterations. To obtain the movement trajectory of a sensor 3, it is sufficient, for example, for an acceleration sensor to record the movements of the apparatus containing the camera module during image capture, and if the image is mechanically stabilized in relation to the movements of the apparatus containing the camera module, it would be sufficient for the absolute residual of non-stabilization to be calculated in relation to the acceleration sensor and the stabilization signal. In another embodiment, in the absence of direct movement measurement data, the image is analyzed to determine the result of the displacement trajectory and to deduce therefrom the composition to be applied to the PSFs to obtain compensation for this movement. In this way, the image I_{R} is also compensated for the blurring effects of residual, uncompensated movement.

3) When the system has several input images Iₑ (same or separate modules), a so-called geometric transformation (GT) entity, referred to as GT or 10 in the present disclosure and in the figures, provides a channel for geometrically transforming each scene to make it spatially coincide with the various other images. This GT 10 is generally non-linear to take account of distortion differences between the camera modules if there are several of them and imperfections in the modeling of geometric distortions, or if the scene has moved relative to the camera module(s) between the different images. When there is only one image, the GT can be seen as the identity. With several Iₑ images as input, one of the images can be considered as untransformed and the GT can be calculated for the others. Each other GT of each image can be calculated by, for example, looking for correlation maxima by shifting parts of one input image Iₑ relative to another, for example the first in the series, and keeping the translation that produced the best correlation. This operation must be repeated on several parts of each image, but not necessarily on all parts of the image. Preferably, the resulting translation field is interpolated by a method such as linear interpolation, or preferably cubic interpolation, or any other method that allows such interpolation. All these interpolations are used to obtain complete coverage of the image field for each GT operator.

The rendering 8 comprises displaying the rendered image I_{R} on a screen, by display means forming part of the device embodiment according to the invention.

The rendered image I_{R} has a resolution greater than or equal to that of the combination of all the photosites of all the colors of the at least one sensor 3.

In a preferential embodiment, the image processing method 1 can restore an image I_{R} with a resolution at least as high as that of the individual photosites of the different colors, or even higher, in order, among other things, to reduce aliasing effects.

Thus, the method 1 (by technical means 6 which are arranged and/or programmed to) simultaneously corrects at least two of the following types of defect in the at least one input image from:
Optical, geometric and/or chromatic aberration, and/or
Distortion, and/or
Mosaicing, and/or
Detection noise, and/or
Blurring, and/or
Residual non-compensation of a movement relative to a scene, and/or
Artifacts induced by spatial discretization of images.

In its full embodiment, this image rendering method 1 compensates for optical projection defects on the sensor 3 or the at least one sensor 3, and reduces light intensity detection noise. In particular, it also compensates for mosaic effects on the sensors 3 with spatially separated detection of several colors, and can also effectively compensate for residual movements of a camera module relative to the scene.

The method 1 is therefore based on full processing of the rendering operations, unlike prior art, which proceeds in successive steps, with the inherent shortcomings mentioned above. This method 1 can take as input the image data detected by at least one sensor 3 in a first channel called ‘input image’ Iₑ, and also in a second channel called ‘optical aberration data’ 9 which can be represented by so-called PSF matrices, optical distortion data provided by the lens assembly or the at least one imaging and focusing system 4 under the relative position conditions of the other optical elements (sensors 3, and scene elements), precise enough to account for these defects at the scale of the light projection on each photosite. In particular, it is preferable to calculate the PSF 9 based on the distances to the various objects in the scene, in order to obtain compensation for these optical aberrations that takes account of the actual focusing distance of each object photographed, thereby increasing the effective depth of field when the image is rendered relative to the state of the art.

In this way, the method 1, in its fullest embodiment, provides an output image known as a rendered image I_{R}. In particular, this image I_{R} has no mosaicing, significant noise reduction according to a setting to be adjusted if necessary, correction of position distortion and image blur adapted to each image region, compensation of relative movements between the lens assembly 4 or the at least one imaging system 4 and the observed scene, for its fullest embodiment, which makes the most of the method 1.

Compared with the prior art, the method 1 avoids dissociated correction steps being stacked on top of one another, thus preventing the effects of defect conjugation inherent in each step. It also makes it possible to limit the scope of the effects of the assumptions that this prior art was led to make, such as the small spatial variation of each color around the detected color photosites to interpolate the values that should have been detected in the absent photosites (because they are in the location of one of the other detected colors).

Different alternatives (which may be combined with one another) of the method according to the invention are therefore conceivable:
In one alternative, if the at least one image sensor 3 does not generate mosaicing, for example owing to a technology for detecting different color channels in the same location, or because it would still be preferable to generate demosaicing by interpolation or some other method for obtaining color values in locations where photosites are physically missing, the method 1 uses such unmosaiced data. It continues to provide very good image rendering quality, for example by continuing to reduce noise and blur in the image, and possibly also to reduce distortions such as deformations with respect to the ideal homothety, for example, if the PSF 9 data presented to the method comprise this distortion information. It will even provide additional demosaicing, if necessary, if only partial demosaicing of input data has been carried out.
In another alternative, where detection comprises mosaicing, it is still preferable to present the non-demosaiced data to the method 1, since the generation of spatially denser image information relative to the input mosaic can be more accurate and involve fewer or no artifacts, depending on the implementation settings of the method 1, whereas prior art demosaicing will involve more artifacts.
In an alternative embodiment which is not preferred (since it would leave blur uncorrected), the method 1 comprises only noise and distortion reduction, without necessarily correcting the aberrations leading to blur. In this case, all that is needed in the convolution channel with PSF 9 is a translation in the (X, Y) plane of the values of a pixel in the rendered image according to the distortion information, without taking blurring effects into account. Formally, this would be equivalent to convolving with a PSF 9 matrix having only one or a few non-zero coefficients, by not retranscribing all the point spread as a whole linked to the point spread information in the PSF matrix presented to the method. And to simplify matters, the value of a pixel may be simply translated rather than multiplying it by zero at certain points to model geometric distortion information. Gradient operations need to be expressed in such a way as to take these translations into account in the calculation modes, in order to obtain the desired effects on the rendered image.
In an alternative, if reducing image noise leads to a reduction in the rendering of details that are not noise, or for any other reason that would make it undesirable to reduce noise using the method, it suffices to modify the weighting of the penalty(s) leading to noise compression in the rendered image I_{R} to leave this aspect in the rendered image, or, if necessary, to construct one or more penalty criteria that are less sensitive to noise (for example, by constructing penalties only to be sensitive to aliasing effects on the edges of image objects, but not to color or luminosity jumps within objects).

The first term D depends on the difference(s) between, on the one hand, the at least one input image Iₑ and, on the other hand, the result I_{ck} of a modification of the image I_{Rk} being rendered at the iteration k at least by a function 9 describing the response of the at least one imaging system.

The first term D may comprise the sum of several terms Di.

Preferably, each distance component Di (1 if i max=1) is calculated as many times as there are different image shots, and summed together, either directly or with weighting coefficients between image shots.

In order to obtain the best possible results from this method 1, a preferably precise knowledge of the optical transfer function 9 is useful, spatially in the image field and also in relation to other possible parameters of relative distance between optical elements, scene, lens assembly, sensor(s) 3, such that inter alia the knowledge of the optical transfer functions 9 (which can be represented by PSF matrices) are possibly differentiated in relation to different distances to the objects in the scene.

The result I_{ck} comprises and/or consists of a convolution product of the image being rendered Irk_{Rk} at the iteration k by the function 9 describing the response of the at least one imaging system, and optionally processed by the geometric transformation GT (referenced 10).

With reference to FIG. 1, Gt(shot p) is the geometric transformation for each image shot p, for example, which models a relative displacement of the scene with respect to the camera module(s) 3,4 (for example, it is the camera module that moves in the case where the scene is a landscape and therefore fixed), and/or models another projection onto another camera module. This GT( ) can model a difference in distance between the 2 modules, if the latter is not integrated into the PSF 9.

The PSF( ) coefficients can be modified slightly to model the fractional part of scene displacement, which does not correspond to the PSF grid spacing, in special cases where this parameter is fixed. In the case of an object-oriented implementation representing the image, however, this remark is not necessary, as the convolution at the PSF must in any case adapt to non-aligned coordinates on a particular grid for each object. In the latter case, the GT acts on a local displacement of each object and its contour. If the object is large, GT( ) can also distort its appearance by applying different displacements to its various parts.

The GT function can be placed before or after the convolution of I_{Rk} with the PSF 9. Preferentially, it can be placed after to avoid repeating convolution operations for each input image.

The function 9 describing the response of the at least one imaging system 4 is an optical transfer function (OTF) of the at least one imaging system or a point spread function (PSF) of the at least one imaging system.

The function 9 describing the response of the at least one imaging system depends on:
a distance (Z) between the at least one sensor 3 and an object imaged by the at least one sensor 3, and/or
a distance (z_{co}) between a part of the at least one imaging system 4 and the at least one sensor 3, and/or
a distance (zₒₛ) between a part of the at least one imaging system 4 and an object imaged by the at least one sensor 3, and/or
a state of the at least one imaging system 4, such as a zoom or focus or digital aperture setting of the at least one imaging system 4, and/or
the pixel of the image being rendered and/or the photosite of the at least one sensor 3, and/or
one or more angles between the at least one sensor 3 and the at least one imaging system 4.

The second term P comprises:
at least one component P₁ whose effect is minimized for small intensity differences between neighboring pixels of the image I_{Rk} being rendered at the iteration k, and/or
at least one component P₃ whose effect is minimized for small differences in hue between neighboring pixels of the image I_{Rk} being rendered at the iteration k, and/or
at least one component P₂ whose effect is minimized for low frequencies of direction changes between neighboring pixels of the image I_{Rk} drawing a contour.

The second term P may thus comprise a sum of several terms Pi.

We will now look at the implementation details of the method 1.

The method 1 comprises representing the image I_{R}, known as the rendered image, or the image being rendered I_{Rk}, in a table of values known as the rendering table. It contains color values at discretized positions, for example according to the three colors R (red), G (green), B (blue), or in another reference. These elements can be seen as juxtaposed square or rectangular elementary objects, with three (or n_{c}) color properties, in addition to the element width and length properties common to all these elements, as well as the position property implicitly known by their arrangement in successive rows in the table and at a constant interval in each x and y direction (x and y, also noted as X and Y, being two orthogonal directions in the plane of the so-called rendered image I_{R} or the so-called image being rendered I_{Rk}). These objects can be called pixels.

This table depicts elementary objects, preferably with a resolution equal to or greater than that of the combination of all the photosites of all the colors of the at least one sensor 3. It can have a scanning and positioning pitch offset from the photosites of the at least one sensor 3, but preferably in spatial synchronization with the latter. For example, for a Color Filter Array (CFA) of 4 photosites R (Red), G1 (Green 1), G2 (Green 2), B (Blue), arranged in 2×2 rows and columns, it can have a numerical representation, for each of the three color properties R (Red), G (Green), B (blue), of one pixel opposite R (Red), then of one pixel opposite G1, G2, B, that is a total of 4 pixels comprising an R, G, B channel, in spatial correspondence with the 4 detection photosites R, G1, G2, B, and repeated as many times as necessary in the x and y directions to describe the entire sensor 3 associated with the image Iₑ.

The number of rendering pixels can also be doubled in each X and Y direction, which would make 16 pixels rendering Red, Green, Blue for each CFA elementary cell. This ratio, known as oversampling, has a value here of 2×2=4 for the two directions x and y at the same time (if the CFA elementary pattern comprises 2×2 photosites). Other ratios would obviously be possible.

It would also be possible to downsample, although this would not improve the quality of the I_{Rk} or I_{R} image in terms of sharpness, but would enable good quality of a compressed I_{R} or I_{Rk} image (in terms of number of pixels).

This table can also be completed, or replaced by a list of objects describing the I_{Rk} or I_{R}. Each object can thus be the square or rectangle pixel, or objects with more properties such as an outline, average color components, but also brightness and color gradient components, for example, and a particular shape. This second depiction allows greater freedom in representing positions, optionally with coordinates represented by numbers having greater resolution than a collection of pixels at predefined locations. In addition, the colors and intensities of objects superimposed at certain points can be added together.

Formally, we write the rendered image I_{Rk} at the iteration k (I_{Rk}) as the sum of the nₘ objects Oₘₖ representing it:

$${I}_{Rk} = {\sum }_{m = 1}^{n m} {O}_{mk} \qquad [ Math . 1 ]$$

The method 1 comprises an output channel for the rendered image I_{R}, which can be a storage of the image being rendered I_{Rk}, at a stage when it is deemed renderable in relation to the rendering method when it is iterative.

In the case where the image I_{Rk} or I_{R} is a sum of different pixel objects, it may be necessary to calculate the value generated by each object for each color, according to the x, y grid chosen to render the image I_{R}, at the output of the method 1.

The image I_{R} can also be output in the form of its objects directly, if this is advantageous in terms of data volume, or in order to obtain a so-called vectorized output format.

The format in which the image I_{R} is rendered can advantageously be in one of the object representations described in the embodiment, in order to benefit from all the resolution finesse and pixelation compensation (discretization) permitted.

Similarly, when comparing the distances Di between the convolved image and the PSFs 9, the method 1 can perform this same type of local color evaluation in the objects opposite the PSF discretization grid, so as to know the colors calculated in place of the input image photosite positions in order to make distance comparisons in the right places, without shifting, for maximum rendering accuracy.

We will now describe various possible ways of implementing the method 1. The aim is to build a way of directly taking into account the whole model of optical defects, between the at least one input image Iₑ represented by the values of the different color components of the photosites and the calculation that the optical defects induce at these locations, from the image being rendered I_{Rk}.

The optical defect model 9 is taken into account by calculating the effects it induces on the basis of the image being rendered I_{Rk}, by composing this image I_{Rk} with the optical defect model 9, for example by means of a convolution product between the matrix of luminance values of I_{Rk} (at each point of a sufficiently fine grid), and the so-called point spread function (PSF) matrix 9 on this same grid, which in output provides a matrix of values on a grid I_{ck} (grid which allows comparison with the photosites at the sensor 3 corresponding to the input image Iₑ).

Of course, a convolution calculation can be carried out by multiplication in the frequency domain, and it is also possible to take into account the effects of point spreading by means of the spatial Fourier transforms of PSF matrices 9, generally called OTF (Optical Transfer Function), which then simply need to be multiplied with the Fourier transforms of the image being rendered, then returned to the spatial domain by inverse transform, if this operating mode is of interest.

Formally, this is written:

I_{ck}=TG(Iᵣₖ)(*)PSF

where (*) stands for convolution product.

GT( ) can be the identity, or a geometric transformation, which consists in locally moving the elements, either by pixel translation in such a representation, or by equivalent modification of the PSFs by recalculating the set of coefficients to take this transformation into account, or possibly a mixture of the two.

It can also be written:

I_{ck}=TG(Irk(*)PSF)

which means that the transformation is carried out after application of the PSF. In this case, the advantage is that it is not necessary to recalculate the convolution product for the different images, which limits the amount of calculations.

An example of how to write I_{ck}, to take into account that each point spread function 9, originating from a point (xi, yi) in the scene can produce a different point spread, is:

$${I}_{c k} ( {i}_{c x} , {i}_{c y} , {i}_{coul} ) = {\sum }_{{i}_{y} = - Δ y}^{Δ y} {\sum }_{{i}_{x} = - Δ x}^{Δ x} {C}_{rk} ( {i}_{rx} + {i}_{x} , {i}_{ry} + {i}_{y} , c ) * PSF ( {i}_{c x} , {i}_{c y} , {i}_{r x} + {i}_{x} , {i}_{r y} + {i}_{y} ) \qquad [ Math . 2 ]$$

irx and iry are selected corresponding to icx and icy.

For example, if at least one input image Iₑ comprises a rendered pixel (with 3 colors) opposite each photosite.

where Δx and Δy are values generally much smaller than the number of photosites in the screen, they are chosen to represent the places where point spread produces a significantly non-zero value.

The first 2 indices of the PSF( ) matrix represent the point spread, obtained for a point xi, yi, which would be the luminance value of the scene for this point of the scene corresponding to this xi, yi of the sensor.

The above calculation therefore comes down to considering the point spread values at the sensor's (xi, yi) locations, by considering the various points in the scene corresponding to the sensor's (xi+x, yi+y) points.

This notion is indexed by physical notations. In a computer representation, PSFs tend to be written differently, as many coefficients would be zero in xi, yi for the first 2 indices: they are re-centered around the first 2 indices, to obtain physically more compact tables of non-zero values. This is an implementation detail that does not change the principle.

I_{ck} is the value of the color component c, at position (xi, yi) obtained on the sensor, at the iteration k, therefore as a convolution of the image being rendered, at the iteration k, represented by color components Cᵣₖ, at positions (xi+x, yi+y) for color c.

From this calculation, a first indicator or term is created called distance D₁, possibly supplemented by other terms D₂ . . . D_{nd}, resulting from a comparison between I_{ck} and Iₑ, which is denoted D₁(I_{ck}, Iₑ):

$$D = {D}_{1} ( {I}_{ck} , {I}_{e} ) + {D}_{2} + … + {D}_{nd}$$

where

D=D₁(I_{ck},Iₑ)

In parallel, one or more penalties are calculated, called P₁, P₂, . . . Pₙₚ, directly from the image Iᵣₖ.

To ensure that the image I_{Rk} is the best possible representation of the observed scene, it is then iterated, hence the index k.

The result is an overall deviation indicator E:

$$E = {\sum }_{i = 1}^{n d} {α}_{i} {D}_{i} + {\sum }_{i = 1}^{n p} {β}_{i} {P}_{i} \qquad [ Math . 3 ]$$

where nd is the number of distances Di,
np the number of penalties Pi
with, for example:
nd=1
np=1
α₁=1
β₁ which can be adjusted to give more or less weight between the distance that forces conformance to the input image Iₑ (or input images), and the penalty that forces the image I_{Rk} or I_{R} to conform to some other property, or to possess a certain consistency with respect to the images that the camera module or the at least one camera module is meant to observe, which also amounts to saying that this penalty indicator also makes it possible to select the images that are most likely to be observed among those that will be rendered. For example, it is unlikely to observe an image I_{Rk} or I_{R} with red/green/blue “snow” within its textures, and it can be said that the penalty indicator P is constructed to make the appearance of such rendered images I_{R} less likely, when it is constructed to be sensitive to color noise in the image I_{Rk} or I_{R}.

The aim of the method is to obtain a rendered image Iᵣ that minimizes the indicator E.

Except in special cases where the expression of the distance Di would allow a direct calculation to minimize it, and where the penalty Pi would also allow it, or would be taken to be zero, the general method of resolution can be obtained, for example, by a so-called Newtonian gradient method, which allows the minimum of a function to be found, by varying the input parameters in the inverse of the gradient of a function E, to minimize its value.

At each step, the sum of the derivatives of each term of E with respect to the set of parameters of the rendered image Iᵣₖ is thus calculated, and the elements of the image I_{Rk} are then made to evolve with respect to this gradient.

The aim of the iterations 7 is to modify the image Iᵣₖ at each step, so as to minimize the indicator E.

In addition, preferentially, contour search operations are carried out on the rendered image I_{Rk} or I_{R} in at least some iterations, in order to create, move or modify a contour.

The distance D or distances Di are therefore derived from Irk (*) PSF (or TG(Irk (*) PSF), while P or Pi are derived directly from Irk.

At the end of the rendering process 8, either the value of E is deemed sufficiently small, or an estimate of the gradients relative thereto is sufficiently small, or the number of iterations is limited to estimate that the image obtained is renderable.

The calculations of the distances Di are preferentially based on all photosite positions. It is therefore necessary to calculate the values of the various color intensities from Irk (*) PSF.

The penalties Pi can be calculated at positions not necessarily related to photosite positions. This can be done on the basis of elementary objects, known as pixels in the rendered image, or on the basis of properties of larger objects, without necessarily displaying color properties according to the precise image rendering grid or PSF, for example, but by means of a more global calculation based on object properties.

A first phase of iterative modification 7 consists in generating an initialization of the rendering table values, that is, determining I_{Rk} for k=1. There are several possible embodiments:

a) The values of the so-called ‘input’ image Iₑ described above can be copied directly. When image blurring and distortion are minor, this option is preferable in terms of ease of use.

b) Preferentially, from the point spread functions (PSF) 9, a certain inversion of the matrix representing it is calculated, at least over the lowest, significant spatial frequencies. Based on this so-called iPSF matrix, which can preferentially be specific to each wavelength and each position in the field, a convolution product is produced with the values of neighboring photosites from the input image Iₑ to produce a first image value I_{Rk} to initialize the rendering table.

c) In cases where at least one image Iₑ is taken in video mode, or if it is deemed to change slowly, the value of the previous rendered image can also be left as the initialization value for the rendering table, except at the start of the video sequence, when it is preferable to proceed as indicated in cases a or b above.

A second phase of iterative modification 7 (possibly reduced to a single iteration, without initialization) consists in using a direct calculation of propagation of the image I_{Rk}, through a image convolution of the rendering table with local point spread function (PSF) matrices 9, which will preferentially be specific per color channel, per position in the at least one sensor 3, and may also depend on other parameters such as the distance z_{co} between the lens assembly 4 or the at least one imaging system 4 and the sensor 3 or the at least one sensor 3, and between the lens assembly 4 or the at least one imaging system 4 and the various objects in the scene, which distance zₒₛ(p) is preferably regionalized for each part ‘p’ of the image I_{Rk}, so as to best model the optical transfer function 9 between the scene and the sensor 3 or at least one sensor 3, for its various color channels.

This direct calculation makes it possible to estimate the deviation indicator between the image obtained by the pixels of the sensors 3, and the calculated one. There are various ways of obtaining the image I_{R}:

Either, less preferentially, an inversion in the least squares sense is calculated, in order to find the best image which, convoluted by the PSF 9 field described above, provides a minimum ‘error distance’ with respect to the image obtained on the sensor 3 or the at least one sensor 3, for example for the three color channels, weighted with the same weight, or not. In this case, reference is made to known least-squares methods. It will also be noted that initialization may not be necessary, and that there is only one iteration on image rendering (although the least squares method leads to the generation of a square matrix that must be inverted, which is an iteration internal to this calculation and in a way replaces the iterations discussed below).

Or, preferably, in order to obtain a better noise resistance of the rendered image, we proceed by iteration, starting from the initial value I_{Rk} for k=1 present in the rendering table, which will be changed at each step. In order to calculate how the rendering table should evolve, the rendering will be indexed by the integer k at each iteration step.

In order to guide the evolution of the image I_{Rk} rendering table, a first term, for example formally called D₁, is calculated as the sum of squares of the deviations between the rendered image I_{Rk} conversion table (image at step k) convolved by the local PSFs. Other distances Di are also possible, such as the sum of absolute values, or any other function that reduces the distance D when the pixel values of the two images come closer together.

When a term of this distance D can be formally derived in order to directly calculate a local matrix of partial derivatives ∂y/∂x of each term of D between the value y of the color at the position of a photosite of the at least one input image Iₑ, and the value x of one of the properties of the elements of the reconstructed image I_{Rk} or I_{R}, such as its value, it is preferable to do so to limit calculations. In this case, it is a matter of including terms from local PSF matrices in these calculations.

Alternatively, it is possible to proceed by finite difference, which provides an estimator of the derivative.

These gradients need only be calculated at positions where there are color-measuring photosites in at least one input image Iₑ. At the other locations, the gradient is by definition zero, which means that it can be formally referred to in the present description, but no calculations will need to be performed at these positions.

To clarify the embodiment examples in the present description, it should be noted that at least two coordinate spaces can be considered: a space called ξr associated with the image being reconstructed I_{Rk}, and a space called ξc associated with the input image or images Iₑ of the method 1. In the case of several input images Iₑ, several spaces can be considered, called ξce, with e an index for naming them.

In the case where the rendered image I_{Rk} or I_{R} is described by a juxtaposition of pixels, for a rectangular shape, ξr can be described by two indices iᵣₓ and i_{ry} which take their values between 1 and nₓᵣ and 1 and n_{yr} respectively, nₓᵣ and n_{yr} being the number of pixels. Shapes other than the rectangle are obviously possible, which can complicate this description of the indices.

The corresponding physical positions can then, for example, be written:

xr(irx,iry)=iᵣₓ*PasImgRx,

yr(irx,iry)=i_{ry}*PasImgRy,

with PasImgRx and PasImgRy the distances between pixels in x and y directions. These physical distances remain relative: they depend on the scale at which the image I_{Rk} or I_{R} is rendered. However, they will need to be connected to the physical distances of the image sensor 3 or the at least one sensor 3, to enable PSF 9 convolution calculations at the correct scale, between the rendered image I_{Rk} or I_{R} and the image(s) at the sensor I_{ck}.

Associated with the space ξr, the i_{rcoul} index is also introduced, which will be used to index the elements that follow in relation to their properties associated with the color components in the rendered image. For example, i_{coul} can take a value between 1 and 3, 1 for Red, 2 for Green, 3 for Blue in the rendered image. If required, more color components can be rendered, e.g. an infra-red component, an ultra-violet component, the number 3 here being recommended in relation to the 3-color display mode of screens and our human tri-chromy, which is by no means limiting with regard to other values.

The methods described in this method 1 can also be applied to a black and white (that is, gray scale) image, in which case i_{coul} is assumed to be 1.

For the input image(s) Iₑ, if it is rectangular, made up of elementary rectangular color acquisition blocks (known as CFAs), it is preferable to identify the precise position of each CFA photosite of each color in relation to a common reference frame, rather than, for example, associating a common coordinate with all the photosites of each color in the same elementary CFA, in order to calculate the value of the rendered image I_{Rk} or I_{R} by transforming the rendered image to the sensor image I_{ck} at the precise position of each color for each photosite. For example, consider a coordinate index system describing the position of each CFA elementary block, then add the shift for the position of each photosite.

For example, we call i_{cx} and i_{cy} the indices in the sensor (hence the ‘c’), varying between 1 and n_{xc} and 1 and n_{yc}, respectively. We add a 3^{rd} index i_{coul} to address the photosite type (coul like color), for example ranging from 1 to 4 for R, G1, G2, B for Red, Green1, Green2, Blue, respectively.

The physical position of each photosite is written as:

$${x}_{c} ( {i}_{cx} , {i}_{cy} , {i}_{coul} ) = {i}_{{cx}^{*}} PasCFAx + PosX ( {i}_{coul} ) ,$$

$${y}_{c} ( {i}_{cx} , {i}_{cy} , {i}_{coul} ) = {i}_{cy} * PasCFAy + PosY ( {i}_{coul} ) ,$$

where PasCFAx represents the displacement between each CFA block in x, and similarly in y for PasCFAy.
and PosX(i_{coul}) marks the physical displacement in the CFA block for the position of each photosite, as does PosY(i_{coul}) in y.

The distance unit is the same for PasCFAx or y and PosX(i_{coul}) or PosY(i_{coul}).

We then need to express the geometric transformation and optical transfer elements, to take as input the physical positions of the reference frame associated with ξr, and as output that of the reference frame associated with ξce. In the case of discretization of these reference frames by the indices that scan the positions of rendered pixels on the one hand, and those (the indices) of the photosite blocks (or directly of the photosites) on the other, the optical transfer transformations can take the form of a matrix product, with ad hoc management of the indices to obtain the correspondences of the physical positions between the rendered image and the image perceived at sensor level (or the images at sensor 3 level).

If, during geometrical transformation calculations, geometrical transformation shifts provide, for example, positions that shift away from discretized positions (that is, calculated position indices that acquire a non-zero fractional part), it would be ideal, for example, to interpolate pixel values in the rendered image frame, to obtain an input matrix with positions compatible with the PSF matrix, for example, so that the output coefficients of the rendered image (x) PSF convolution correspond to photosite positions, without shifts. If this precaution is not taken, the quality of the rendered image I_{R} may suffer from defects such as shifts between the rendered colors, resulting, for example, in the appearance of colored fringe residues around the elements of the rendered image, or geometric micro-distortions linked to these fractional parts in the indices of calculated positions not taken into account.

As an example of the correspondence between the space ξr and the space ξr, assume that the rendered image I_{Rk} or I_{R} comprises 1 pixel (that is, 3 colors) in front of each photosite, and that the CFA has 4 photosites R, G1, G2, B.

Index offsets (Icfa_x, Icfa_y) can be defined to access photosites relative to the CFA origin, by:

$$for {i}_{coul} = 1 ( for R ) , ( {l}_{cfa \_ x} , {l}_{cfa \_ y} ) = ( 1 , 0 ) ;$$

$$for {i}_{coul} = 2 ( for G 1 ) , ( {l}_{cfa \_ x} , {l}_{cfa \_ y} ) = ( 1 , 1 ) ;$$

$$for {i}_{coul} = 3 ( for G 2 ) , ( {l}_{cfa \_ x} , {l}_{cfa \_ y} ) = ( 0 , 0 ) ;$$

$$for {i}_{coul} = 4 ( for B ) , ( {l}_{cfa \_ x} , {l}_{cfa \_ y} ) = ( 0 , 1 ) ;$$

It is therefore noted that i_{coul} does not strictly identify the color received, but rather the position index in the CFA block, which leads us to know a fortiori its color component. Of course, there could be a 5^{th} photosite with infrared dominance and a 6^{th} with ultraviolet dominance, making, for example, 6 possible values for i_{coul}.

For the CFA block (change from rendered image to CFA block):

$${i}_{cx} = 1 + ( {i}_{rx} - 1 ) / 2$$

$${i}_{cy} = 1 + ( {i}_{ry} - 1 ) / 2$$

For an image pixel, using the offsets (I_{cfa_x}, I_{cfa_y}) defined previously (sensor index to rendered image transition):

$${i}_{rx} = 1 + ( {i}_{cx} - 1 ) * 2 + {1}_{{cfa}_{-} x} ( {i}_{coul} )$$

$${i}_{ry} = 1 + {( {i}_{cy} - 1 )}^{} * 2 + {1}_{{cfa}_{-} y} ( {i}_{coul} )$$

The function D or D1 can optionally also be summed over sub-regions of the image, for example, with different weightings to adapt the solution found to specific image characteristics. In addition, D1 can be combined with at least one other function, D2, calculated in a different way, to give a different sensitivity in a given amplitude range, for example.

In particular, the color detection matrix may have a different exposure or collection area for green pixels G1 and G2, for example, so that if pixel G1 saturates or is close to saturation in a certain part of the image I_{Rk} or I_{R}, the pixel G2 still provides an unsaturated response in this part. Generally speaking, photosites G1 close to saturation can be grouped under the symbol Phₕₙ(i_{cx}, i_{cy},i_{coul}) in the expressions below (hn as high signal level) and other photosites R, G2, B as well as G1 in dimly lit parts of the image under the symbol Phon (i_{cx}, i_{cy},i_{coul}) (bn as low signal level).

In this case, for example, when calculating distance(s) D, consider;

$${D}_{1} = {A}_{1} * {\sum }_{( {i}_{cx} , {i}_{c y} , {i}_{coul} ) ∈ \{ photosites near saturation \}} {( {I}_{ck} ( {i}_{cx} , {i}_{cy} , {i}_{coul} ) - P {h}_{h n} ( {i}_{cx} , {i}_{cy} , {i}_{coul} ) )}^{2} \qquad [ Math . 4 ]$$

$${D}_{2} = {A}_{2} * {\sum }_{( {i}_{cx} , {i}_{c y} , {i}_{coul} ) ∈ \{ photosites far from saturation \}} {( {I}_{c k} ( {i}_{cx} , {i}_{cy} , {i}_{coul} ) - P {h}_{bn} ( {i}_{cx} , {i}_{cy} , {i}_{coul} ) )}^{2} \qquad [ Math . 5 ]$$

If any photosites are reliably saturated, they should preferably be excluded from the above summations.

The first distance D₁ is therefore calculated with photosites that are close to saturation or potentially saturated (such saturation can, for example, be assessed according to a criterion of significant reduction of the derivative of the relationship between the measured value and the luminance received, below a certain value), and the second distance D₂ is calculated with the photosites identified as being far from saturation (such absence of saturation may, for example, be assessed according to a criterion of maintaining the derivative of the relationship between the measured value and the luminance received above a certain value).

I_{ck} is the calculation of the composite (convolved) rendered image with PSF 9 information, and A1 and A2 are two weighting coefficients.

To then take photosite saturation into account, A1 can be significantly attenuated compared to A2 and the rest of the other coefficients (applied to the “penalty” operators), so that the rendered image solution does not take much account of these close or potentially saturated photosites, which would therefore not provide reliable information.

If desired, in order to implement the method 1 in a preferable mode that reduces noise or aliasing effects, at least one further so-called global penalty term P₁ is to be calculated, optionally supplemented by further terms P₂, . . . Pₙ.

This term P₁ may, for example, correspond to a so-called penalty function calculated as follows:
the 3 components Rₖ(iᵣₓ,i_{ry}), Vₖ(iᵣₓ,i_{ry}), Bₖ(iᵣₓ,i_{ry}) in each position of the rendering table are first named, also called Cₖ(iᵣₓ,i_{ry}, i_{rcoul}), to bring them together under the index c.

This function P₁ can be the sum over the 3 or nc colors, of the sum over the field (irx, iry) of the absolute values (noted |⋅|) of the differences between each component:

$$Delta ( {i}_{r x} , {i}_{r y} , {i}_{coul} ) = \vert {C}_{k} ( {i}_{rx} + 1 , {I}_{ry} , {i}_{rcoul} ) - {C}_{k} ( {i}_{rx} , {i}_{ry} , {i}_{rcoul} ) \vert + \vert {C}_{k} ( {i}_{rx} , {i}_{ry} + 1 , {i}_{rcoul} ) - {C}_{k} ( {i}_{r x} , {i}_{r y} , {i}_{rcoul} ) \vert$$

A derivation of this function P1 is then evaluated with respect to the value of each pixel of each color, for example where photosites of the measured color exist, or for the set of discretized positions of x, y.

In the particular example of this embodiment, the presence of the absolute values |⋅| can make it necessary to calculate this gradient numerically (by finite difference), and not simply from a formal derivation of Delta(iᵣₓ,i_{ry}, i_{rcoul}).

This function P₁ has been chosen here because it prevents the solution that will be calculated at each iteration from containing high-frequency noise components, as it tends to increase the value of P₁ when value discrepancies occur between neighboring pixels. In particular, this effect tends to counterbalance the effects of noise present in the original image, and which tend to be replicated in the image restored from the measurement D₁.

This way of obtaining the penalty P₁ is given as an example only. We can also construct a penalty operator P₃ (which complements or replaces P₁) that penalizes rapid variations in hue in the image, for example using the formulation:

$$Delta ( {i}_{rx} , {i}_{ry} ) = \vert {U}_{k} ( {i}_{rx} + 1 , {i}_{ry} ) - {U}_{k} ( {i}_{rx} , {i}_{ry} ) \vert + \vert {V}_{k} ( {i}_{rx} , {i}_{ry} + 1 ) - {V}_{k} ( {i}_{rx} , {i}_{ry} ) \vert$$

with U and V the decompositions in a Chroma 1 (U), Chroma2 (V), Luminance (Y) system, that is, Y=(R+G+B) and U=B−Y and V=R−Y for example (without involving any particular notion of projection on a color rendering diagram, to keep this description simple). (The Green of the image is called G above to avoid confusion with the V value of chroma 2)

This example for P₃ therefore shows that the penalty excludes the luminance value, which is free to reproduce that of the observed object, but that the color rendering is strongly constrained, preventing noise from being significantly expressed therein.

These are just two examples, and other less simple ones are also possible, for example by combining more distant pixels together, and assigning different weights to difference calculations for U and V on the one hand, and Y on the other.

P can also be constructed as the minimum of several penalty functions generated according to other combinations, or functions more complex than multiplications and additions from the color pixels rendered in step k.

At this stage, it is not strictly necessary to add a penalty P₂ to the calculation of P₁ and/or P₃. However, it can be used as a complement, for example to create a penalty on a more global property of the objects in the image being rendered. For example, it can be used to create a particular property relating to the contours of the object being rendered (by high contrast detection, for example).

In this way, frequent changes of direction can be minimized in the penalty P₂. It is possible to locally calculate the direction (vector dx, dy) of the local direction of the contour, and to calculate an indicator that increases when this direction changes, preferably using a square, or an absolute value to add any change that cannot be offset by a change further away, of opposite sign.

Thus, P₂ increases, for example, if the contours of the luminance Y zigzag. Thus in P₂, the previous locally calculated penalty indicators can be summed over the entire x, y field.

In the following, the term Gradient, represented by the operator grad( ), refers to the set of partial derivatives of a distance or penalty of an elementary object Cₖ(iᵣₓ,i_{ry}, i_{rcoul}) of the rendered image, that is, typically the coordinate vector, the derivatives of a distance D or Dᵢ or penalty P or Pᵢ with respect to, for example, the set of the n_{c} colors of Cₖ(iᵣₓ,i_{ry}, i_{rcoul}), and this for each x, y, c describing the image, or in the following, the partial derivatives with respect to other properties describing the object Oₘₖ, such as the parameters of its contour, its colors, its color gradients.

Similarly, grad(P₂) (x, y, c), or its finite difference is calculated when derivation is not possible.

The result is:

$$grad ( E ) ( {i}_{rx} , {i}_{ry} , {i}_{rcoul} ) = grad ( {D}_{1} ) ( {i}_{rx} , {i}_{ry} , {i}_{rcoul} ) + {β}_{1} grad ( {P}_{1} ) ( {i}_{rx} , {i}_{ry} , {i}_{rcoul} ) + {β}_{2} grad ( {P}_{2} ) ( {i}_{rx} , {i}_{ry} , {i}_{rcoul} ) + … + {β}_{n} grad ( {P}_{n} ) ( {i}_{rx} , {i}_{ry} , {i}_{rcoul} )$$

The coefficients β₁, . . . βₙ, which are not necessarily fixed, are chosen so as to obtain the desired trade-off between image rendering fidelity with respect to the photosites of the at least one input image Iₑ, and the desired noise reduction constraint, for example. Depending on the application, these coefficients can be modified according to the type of image, or regionalized by image part, which amounts to dividing the sum contained in each term Pᵢ into several sub-sums with different coefficients β, in order, if necessary, to best adapt the rendering of a noise-free image that is as faithful as possible to the measurements.

Technically speaking, for x, y not affected by a photosite detecting color c, grad(D₁) y is zero by definition (since no comparison of the reconstructed image is possible there). It is then necessary to choose the indicators in such a way as to make at least one grad(Pᵢ) non-zero, in order to create a choice constraint in these positions.

Alternatively, to determine the pixels outside the detection grid of the sensor 3 or at least one sensor 3, linear or cubic interpolation can be used, or any other method that selects points that do not degrade preferably the image noise, that is, generally a method that favors low spatial frequencies over adjacent points. They can also be selected using a method that minimizes the aliasing of contours, when these points belong to an object contour, according to a previously mentioned criterion to be set up.

Then, for each position x, y, and each color i_{rcoul}:

$${C}_{k + 1} ( {i}_{rx} , {i}_{ry} , {i}_{rcou1 )} = {C}_{k} ( {i}_{rx} , {i}_{ry} , {i}_{rcoul} ) - G ⋆ grad ( E ) ( {i}_{rx} , {i}_{ry} , {i}_{rcoul )}$$

The value of the coefficient G can be calculated and, if necessary, adjusted at each iteration k, in order to avoid possible oscillation of the solution as well as its rapid convergence. The skilled artisan can refer to the numerous methods in the literature for finding solutions to a function using Newton's gradient method.

Thus, the solution Cₖ₊₁(iᵣₓ,i_{ry}, i_{rcoul}) must end up minimizing the sum of Dᵢ and αᵢ Pᵢ.

To this end, it is preferable to choose so-called convex functions for these different indicators, which in theory ensures the uniqueness of the solution sought. If this is not the case, additional iterations can be added, and the skilled person can use thermal annealing methods, for example, to escape from local minima.

The iteration operation can be repeated to obtain, for example, a minimum value of grad(E)(iᵣₓ,i_{ry}, i_{rcoul}) below a certain threshold, at the iteration k, which is then deemed to be the last. Iterations may also be stopped after a certain number of iterations (considering that the adjustments should become negligible, or simply because the image rendering time would become too long).

The resulting solution Cₖ(iᵣₓ,i_{ry}, i_{rcoul}) then represents the so-called processed image. This triggers the exit from the iteration loop, and the obtainment of the rendered image I_{R}.

Overall, the first constraint on the function D or D₁ creates a force that tends to cause the rendered image to pass between the points of the image obtained on the sensor.

The function P₁ or P₃ creates a force that prevents neighboring points from deviating too much in value, for the 2 examples shown. It therefore reduces the noise of the rendered image compared to the potentially noisy initial image.

The function P₂ creates a force that limits the aliasing effects on the edges of objects, for the example shown.

Other functions Dᵢ or Pᵢ can be added, or other ways of writing the iteration, in order, for example, to better model variations in image texture within objects, but this other example is of course not limiting and many other ways of creating penalty methods are imaginable, in order to guide the rendering of the image toward a given other type of image.

By way of example, it is possible to guide the solution according to the invention toward a black and white image, simply by heavily penalizing the aforementioned U and V terms to force them to remain close to zero. On the contrary, the color saturation of the resulting image can be accentuated by penalizing the luminance Y more. And if necessary, this may be done according to other criteria that may be sensitive to a particular characteristic of an image zone. Again by way of example, a penalty function may be created whereby if the green component has a strong local variation, but the other two Red and Blue components do not, which may correspond to the foliage of a landscape, then the penalty is reduced, which would have the effect of eventually leaving more noise in the rendered image because the noise would be less perceptible in these areas. Therefore, the embodiment examples of penalty functions are provided solely as examples and do not constitute limitations on writing other types of penalty functions.

The image rendered at step k was previously written from Cₖ(iᵣₓ,i_{ry}, i_{rcoul}), where iᵣₓ and i_{ry} scan the set of indices of the positions in the image field. And c is the set of the colors. Cₖ(iᵣₓ,i_{ry}, i_{rcoul}) correspond to elementary objects, with zero intensity in all three colors outside a rectangle (or generally a square) represented by their center located at (x, y), and with sides equal to the discretization step of positions xᵣ and yᵣ.

A further embodiment can therefore preferentially provide better results by merging these squares when they are contiguous and have similar optical properties, in the sense, for example, of the same operation described for the penalty P₁ or P₃.

In order to replace these elementary patterns locally by larger objects, when the elementary calculation kernel of P₁(x, y, c) or P₃(x, y, c) is below a certain threshold, at each point (x, y), it is then possible to create an object called Oₘ whose index m allows it to be arranged in a list of objects, to which, for example, an average of the properties of the c∈{1 . . . n_{c}} components Cₖ(x, y, c) is transferred, for example. The object Oₘ can then be completed with a vectorized contour description, that is, no longer resulting from the joining of the initial squares, but from the parameterization of a line describing this boundary. This line can then be created to avoid pixel aliasing.

Regarding the objects Oₘₖ, they can generally be selected from a base of objects, such as elementary geometric shapes (rectangles, circles, curved lines, etc.).

The method of representing the rendered image at step k can then also be written:

$${I}_{k} = {\sum }_{m} {O}_{mk} \qquad [ Math . 6 ]$$

where each Oₘₖ represents a non-zero function on only part of the image.

The function(s) Dᵢ and penalty(s) Pᵢ are then written as involving these Oₘₖ(x, y, c), that is, the value of the object m at a position x, y of the sensor field, and expressed for a color component.

For the parts of the image I_{Rk} or I_{R} that did not allow the creation of an object combining several squares, these squares can be included in the list of objects Oₘₖ, which is then extended with these square objects of side pₓ, p_{y}, the discretization steps x, y, called elementary objects.

It then suffices to add up the above indicators on m, the set of objects, in order to calculate them, in addition to the sum on x, y, c.

Formally, this representation of the image I_{Rk} or I_{R} makes it possible, for example, to take objects that contain, by their own properties, properties that can limit the number of calculations. Similarly, the additional calculations required to change the values at pixels other than those from the sensor 3 or the at least one sensor 3, at each iteration k, can disappear, since the value of the color signals can be known as soon as the object is verified only at the photosites of the input image Iₑ (or input images Iₑ).

Thus, the operations and penalty calculations to avoid aliasing can be reduced if objects are naturally not aliased.

Of course, as already mentioned in the description of the gradient operator, in the same way that the method 1 can calculate the derivative of one of the penalties Pᵢ, with respect to variations in the elementary properties of each Cₖ(iᵣₓ,i_{ry}, i_{rcoul}), so that they can be adjusted at each iteration, these gradients can be calculated formally or by finite difference with respect to the properties of the object Oₘₖ, such as variations in the parameters describing the positions of its contours, as well as the color parameters nc, supplemented if necessary by parameters of internal color variations within the object, for example.

To evaluate the gradient of the distances Dᵢ, it is of course also possible to calculate how this distance evolves in relation to variations in the parameters of Oₘₖ.

We can add that it is not necessary for the objects created to be considered as strictly spatially disjoint. Overlapping with neighboring objects can be allowed. In this way, this degree of freedom can perfect the description of the image I_{Rk} or I_{R}, for example that the set of properties of the larger object does not allow the full finesse of color variation in the inside object to be represented. An area of the image I_{Rk} or I_{R} can be described by a background object, to which spatially finer objects within it add color variations, more locally with respect to the whole dP₁(x, y, c) e of the object, even if these objects remain elementary Cₖ(iᵣₓ,i_{ry}, i_{rcoul}).

Thus, the convolution products between the local PSFs and the pixels of the image being rendered I_{Rk} at step k can be pre-calculated with respect to the entire object Oₘₖ, which can reduce the number of calculations to be performed at each iteration.

Thus, the advantages of the invention are:
Not producing a reduction in sharpness at a noise reduction step, which must then be compensated for, with difficulty, in order to maintain good compensation homogeneity across the entire image.
Avoiding the appearance of colored fringes which are often visible around the outlines of objects in the image.
Avoiding the appearance of color noise (a kind of red, green or blue snow) within the texture of objects, or more generally in certain areas of the image.
Including all corrections for distortion and loss of sharpness in the rendered image, evenly and accurately across the entire image.
Improving sharpness over the entire depth of field (in Z) of the image, beyond the sharpness zone of the hyperfocal distance, provided that the Z of each object in the PSF(x,y,c) is taken into account
Avoiding so-called zipper effects on object contours.
Avoiding false color effects in parts of object textures.
Rendering a far better-resolved image than the state of the art, at equivalent pixel density (generally equal to the spacing of the photosites, but not always). In order to fully render the finesse of the image, it is preferable to export it by its objects, such as those described, directly. Any prior art compression or rendering that generally degrading quality.

Within the scope of the present description, also proposed according to the invention is:
a smartphone (also called smart cell phone or multifunction cell phone), implementing any one of the embodiments of the method according to the invention described above to correct an image acquired by the smartphone (more specifically by the camera module(s), comprising a lens assembly and a sensor, of the smartphone) and/or comprising any one of the device embodiments according to the invention described above arranged and/or programmed to correct an image acquired by the smartphone (more specifically by the camera module(s), comprising a lens assembly and a sensor, of the smartphone), and/or
a use of any one of the device embodiments according to the invention described above and/or of any one of the method embodiments according to the invention described above within a smartphone (also called smart cell phone or multifunction cell phone), to correct an image acquired by the smartphone (more specifically by the camera module(s), comprising a lens assembly and a sensor, of the smartphone), and/or
a tablet computer, implementing any one of the method embodiments according to the invention described above to correct an image acquired by the tablet computer (more specifically by the camera module(s), comprising a lens assembly and a sensor, of the tablet computer) and/or comprising any one of the device embodiments according to the invention described above arranged and/or programmed to correct an image acquired by the tablet computer (more specifically by the camera module(s), comprising a lens assembly and a sensor, of the tablet computer), and/or
a use of any one of the device embodiments according to the invention described above and/or any one of the method embodiments according to the invention described above within a tablet computer, to correct an image acquired by the tablet computer (more specifically by the camera module(s), comprising a lens assembly and a sensor, of the tablet computer), and/or
a photographic camera (preferably of the reflex or bridge or compact type), implementing any one of the method embodiments according to the invention described above to correct an image acquired by the photographic camera (more specifically by the camera module(s), comprising a lens assembly and a sensor, of the photographic camera) and/or comprising any one of the device embodiments according to the invention described above arranged and/or programmed to correct an image acquired by the photographic camera (more specifically by the camera module(s), comprising a lens assembly and a sensor, of the photographic camera),
a use of any one of the device embodiments according to the invention described above and/or any one of the method embodiments according to the invention described above within a photographic camera (preferably of the reflex or bridge or compact type), to correct an image acquired by the photographic camera (more specifically by the camera module(s), comprising a lens assembly and a sensor, of the photographic camera), and/or
a vehicle (preferably automotive, but may be of any type), implementing any one of the method embodiments according to the invention described above to correct an image acquired by the vehicle (more specifically by the camera module(s), comprising a lens assembly and a sensor, of the vehicle) and/or comprising any one of the device embodiments according to the invention described above arranged and/or programmed to correct an image acquired by the vehicle (more specifically by the camera module(s), comprising a lens assembly and a sensor, of the vehicle); the corrected image preferably being used or intended to be used by the vehicle for autonomous driving of the vehicle, and/or
a use of any one of the device embodiments according to the invention described above and/or any one of the method embodiments according to the invention described above within a vehicle (preferably automotive, but which may be of any type), to correct an image acquired by the vehicle (more specifically by the camera module(s), comprising a lens assembly and a sensor, of the vehicle); the corrected image preferably being used or intended to be used by the vehicle for autonomous driving of the vehicle, and/or
a video surveillance system (preferably of a building and/or a geographical area), implementing any one of the method embodiments according to the invention described above to correct an image acquired by the video surveillance system (more precisely by the camera module(s), comprising a lens assembly and a sensor, of the video surveillance system) and/or comprising any one of the device embodiments according to the invention described above arranged and/or programmed to correct an image acquired by the video surveillance system (more specifically by the camera module(s), comprising a lens assembly and a sensor, of the video surveillance system), and/or
a use of any one of the device embodiments according to the invention described above and/or any one of the method embodiments according to the invention described above within a video surveillance system (preferably of a building and/or a geographical area), to correct an image acquired by the video surveillance system (more precisely by the camera module(s), comprising a lens assembly and a sensor, of the video surveillance system), and/or
a drone, implementing any one of the method embodiments according to the invention described above to correct an image acquired by the drone (more specifically by the camera module(s), comprising a lens assembly and a sensor, of the drone) and/or comprising any one of the device embodiments according to the invention described above arranged and/or programmed to correct an image acquired by the drone (more specifically by the camera module(s), comprising a lens assembly and a sensor, of the drone); the corrected image preferably being used or intended to be used by the drone:
   in the field of agriculture, the image acquired by the drone preferably being an image of plant crops, and/or
   in the field of pollution and/or land use analysis, the image acquired by the drone preferably being a multi-wavelength band image, and/or
a use of any one of the device embodiments according to the invention described above and/or any one of the method embodiments according to the invention described above within a drone, to correct an image acquired by the drone (more specifically by the camera module(s), comprising a lens assembly and a sensor, of the drone); the corrected image preferably being used or intended to be used by the drone:
   in the field of agriculture, the image acquired by the drone preferably being an image of plant crops, and/or
   in the field of pollution and/or land use analysis, the image acquired by the drone preferably being a multi-wavelength band image, and/or
a satellite, implementing any one of the method embodiments according to the invention described above to correct an image acquired by the satellite (more specifically by the camera module(s), comprising a lens assembly and a sensor, of the satellite) and/or comprising any one of the device embodiments according to the invention described above arranged and/or programmed to correct an image acquired by the satellite (more specifically by the camera module(s), comprising a lens assembly and a sensor, of the satellite); the corrected image preferably being used or intended to be used by the satellite:
   in the field of agriculture, the image acquired by the satellite preferably being an image of plant crops, and/or
   in the field of pollution and/or land use analysis, the image acquired by the satellite preferably being a multi-wavelength band image, and/or
a use of any one of the device embodiments according to the invention described above and/or any one of the method embodiments according to the invention described above within a satellite, to correct an image acquired by the satellite (more specifically by the camera module(s), comprising a lens assembly and a sensor, of the satellite); the corrected image preferably being used or intended to be used by the satellite:
   in the field of agriculture, the image acquired by the satellite preferably being an image of plant crops, and/or
   in the field of pollution and/or land use analysis, the image acquired by the satellite preferably being a multi-wavelength band image, and/or
an apparatus for medical imaging of the human and/or animal body (preferably by MRI and/or X-ray and/or Gamma-ray and/or ultrasound), implementing any one of the method embodiments according to the invention described above to correct an image acquired by the medical imaging apparatus and/or comprising any one of the device embodiments according to the invention described above arranged and/or programmed to correct an image acquired by the medical imaging apparatus, and/or
a use of any one of the device embodiments according to the invention described above and/or any one of the method embodiments according to the invention described above within a medical imaging device for imaging the human and/or animal body (preferably by magnetic resonance imaging and/or X-ray and/or Gamma-ray and/or ultrasound), to correct an image acquired by the medical imaging device, and/or
a microscopy apparatus, implementing any one of the method embodiments according to the invention described above to correct an image acquired by the microscopy apparatus and/or comprising any one of the device embodiments according to the invention described above arranged and/or programmed to correct an image acquired by the microscopy apparatus, and/or
a use of any one of the device embodiments according to the invention described above and/or any one of the method embodiments according to the invention described above within a microscopy apparatus, to correct an image acquired by the microscopy apparatus, and/or
an apparatus for tomographic imaging of an image acquired in several wavelength bands (preferably in the field of health and/or in the field of industry and/or in the field of agriculture), implementing any one of the method embodiments according to the invention described above to correct an image acquired by the tomographic imaging apparatus and/or comprising any one of the device embodiments according to the invention described above arranged and/or programmed to correct an image acquired by the tomographic imaging apparatus, and/or
a use of any one of the device embodiments according to the invention described above and/or any one of the method embodiments according to the invention described above within a tomographic imaging apparatus of an image acquired in several wavelength bands (preferably in the field of health and/or in the field of industry and/or in the field of agriculture), to correct an image acquired by the tomographic imaging apparatus, and/or
a computer program comprising instructions which, when they are executed by a computer, implement the steps of the method according to the invention described above, and/or
a computer program product comprising instructions which, when the program is executed by a computer, cause the computer to perform the steps of the method according to the invention described above, and/or
a computer-readable storage medium comprising instructions which, when executed by a computer, cause the computer to perform the steps of the method according to the invention described above.

Of course, the invention is not limited to the examples just described, and many adjustments can be made to these examples without going beyond the scope of the invention.

In particular, each passage of the preceding description mentioning a sensor 3, an optical system 4 or an input image Iₑ or a camera module can be generalized respectively to at least one sensor 3, at least one optical system 4 or at least one input image Iₑ or at least one camera module.

Of course, the various features, forms, variants and embodiments of the invention may be combined with each other in various combinations as long as they are not incompatible or exclusive of each other. In particular, all the variants and embodiments described above can be combined with each other.

1. A method for correcting at least one input image Iₑ into an image being rendered I_{Rk} and then a rendered image I_{R}, the at least one input image originating from at least one optical sensor provided with photosites of different colors and being obtained through at least one optical imaging system, each sensor being associated with an optical imaging system, said method comprising:
receiving the at least one input image Iₑ;
iteratively modifying the image I_{Rk} being rendered at different iterations k by iteratively processing a function E comprising two terms, that is:
a first term D, which depends on a comparison between, on the one hand, the at least one input image Iₑ and, on the other hand, a result I_{ck} of the image I_{Rk} being rendered at the iteration k reprocessed by information relating to the at least one imaging system; and
a second term P, which depends on one or more anomalies or penalties or defects within the image I_{Rk} being rendered at the iteration k;
until minimizing, at least below a certain minimization threshold or after a certain number of iterations, a cumulative effect:
of one or more differences of the first term D between the at least one input image Iₑ and the result I_{ck}; and
of one or more anomalies or penalties or defects on which the second term P depends within the image I_{Rk} being rendered at the iteration k;
so that the rendered image I_{R} corresponds to the image being rendered at the iteration for which this minimization is obtained.

2. The method according to claim 1, characterized in that it simultaneously corrects at least two of the following types of defect in the at least one input image:
Optical, geometric and/or chromatic aberration, and/or
Distortion, and/or
Mosaicing, and/or
Detection noise, and/or
Blurring, and/or
Residual non-compensation of a movement, and/or
Artifacts induced by spatial discretization.

3. The method according to claim 1, characterized in that the minimization of the cumulative effect corresponds to a minimization of the function E.

4. The method according to claim 1, characterized in that the function E comprises the sum of the first term D and the second term P.

5. The method according to claim 1, characterized in that the first term D depends on the difference(s) between, on the one hand, the at least one input image Iₑ and, on the other hand, the result I_{ck} of a modification of the image I_{Rk} being rendered at the iteration k at least by a function describing the response of the at least one imaging system.

6. The method according to claim 5, characterized in that the result I_{ck} may comprise and/or consist of a convolution product of the image I_{Rk} being rendered at the iteration k by the function describing the response of the at least one imaging system, and possibly processed by a geometric transformation GT.

7. The method according to claim 5, characterized in that the function describing the response of the at least one imaging system is an optical transfer function (OTF) of the at least one imaging system or a point spread function (PSF) of the at least one imaging system.

8. The method according to claim 5, characterized in that the function describing the response of the at least one imaging system depends on:
a distance (Z) between the at least one sensor and an object imaged by the at least one sensor, and/or
a distance (z_{co}) between a part of the at least one imaging system and the at least one sensor, and/or
a distance (zₒₛ) between a part of the at least one imaging system and an object imaged by the at least one sensor, and/or
a state of the at least one imaging system, such as a zoom or focus or digital aperture setting of the at least one imaging system, and/or
the pixel of the image being rendered and/or the photosite of the at least one sensor, and/or
one or more angles between the at least one sensor and the at least one imaging system.

9. The method according to claim 1, characterized in that it comprises passing light through the at least one optical system to the at least one sensor so as to generate the at least one input image.

10. The method according to claim 1, characterized in that it comprises displaying the rendered image on a screen.

11. The method according to claim 1, characterized in that the rendered image has a resolution greater than or equal to that of the combination of all the photosites of all the colors of the at least one sensor.

12. The method according to claim 1, characterized in that it comprises generating, from several input images, an initial version of the image being rendered I_{Rk} for the first iteration k=1 by a combination between these several input images Iₑ.

13. The method according to claim 1, characterized in that the second term P comprises at least one component P₁ whose effect is minimized for small intensity differences between neighboring pixels of the image I_{Rk} being rendered at the iteration k.

14. The method according to claim 1, characterized in that the second term P comprises at least one component P₃ whose effect is minimized for small differences in hue between neighboring pixels of the image being rendered I_{Rk} at the iteration k.

15. The method according to claim 1, characterized in that the second term P comprises at least one component P₂ whose effect is minimized for low frequencies of direction changes between neighboring pixels of the image I_{Rk} drawing a contour.

16. A device for correcting at least one input image Iₑ into an image being rendered I_{Rk} and then a rendered image I_{R}, the at least one input image originating from at least one optical sensor provided with photosites of different colors and being obtained through at least one optical imaging system, each sensor being associated with an optical imaging system, said device comprising:
means for receiving the at least one input image Iₑ;
processing means arranged and/or programmed for iteratively modifying the image I_{Rk} being rendered at different iterations k by iteratively processing a function E comprising two terms, that is:
a first term D, which depends on a comparison between, on the one hand, the at least one input image Iₑ and, on the other hand, a result I_{ck} of the image I_{Rk} being rendered at the iteration k reprocessed by information relating to the at least one imaging system; and
a second term P, which depends on one or more anomalies or penalties or defects within the image I_{Rk} being rendered at the iteration k;
until minimizing, at least below a certain minimization threshold or after a certain number of iterations, a cumulative effect:
of one or more differences of the first term D between the at least one input image Iₑ and the result I_{ck}; and
of one or more anomalies or penalties or defects on which the second term P depends within the image I_{Rk} being rendered at the iteration k;
so that the rendered image I_{R} corresponds to the image being rendered at the iteration for which this minimization is obtained.
